(19) United States
(12) Patent Application Publication
(10) Pub. No.: US 2004/0056600 A1
(43) Pub. Date: Mar. 25, 2004

(54) Electric lamp with condensate reservoir and method of operation thereof

(76) Inventors: Walter P. Lapatovich, Boxford, MA (US); Arlene Hecker, Beverly, MA (US); Miguel Galvez, Danvers, MA (US)

Correspondence Address: William E. Meyer, Osram Sylvania Inc., 100 Endicott Street, Danvers, MA, 01923, US

(21) Appl. No.: 10/247,057

(22) Filed: Sep. 19, 2002

(51) Int. Cl. H01J 61/30; H01J 17/16

(52) U.S. Cl. 313/634

(57) ABSTRACT

A ceramic discharge lamp, and method of operating same, is provided which contains a cavity between a clear sapphire tube and a PCA cap. During lamp operation, the cavity holds the molten salts to act as a constant temperature reservoir of the molten salts. By manipulating the shape of the cap, for example the curvature of the internal dome, or by building in an offsetting lip, the volume of the cavity can be controlled. By adjusting the thickness of the adjacent cap walls, or by the addition of exterior heat sinking or radiating features on the cap, the temperature of the salt reservoir can be further controlled. The reservoir facilitates providing materials for the plasma at a constant pressure, but without letting the fill condensate flow over and coat the light emitting portions of the clear sapphire transmission cavity wall. As a result, the arc has more stable performance, and the generated light escapes without being interfered with by condensed salts, or fluid salts moving on the light transmitting surfaces. In this way the lamp can be overdosed with salts, while functionally appearing to be minimally dosed.

### TECHNICAL FIELD

The present invention relates to an electric lamp, and method of operation thereof, having a lamp envelope that is useful in controlling the melt temperature of the fill material within such envelope. The present invention is particularly of interest regarding a metal halide lamp having such an improved lamp envelope.

### BACKGROUND ART

Lamp manufacturers are constantly searching for ways to improve their products. One such improvement would be the removal of mercury from discharge lamps. However, mercury is beneficial in discharge lamps and leads to lamp systems with high efficiency.

As an example, high intensity discharge (HID) headlamps are an emerging application for mercury in automobiles. These headlamps offer improved visibility, longer life and use less energy than standard tungsten halogen headlamps. Each HID light source contains approximately 0.5 mg of mercury and passes the Federal TCLP test for hazardous waste. The European Union ELV (end-of life vehicles) directive exempts mercury-containing bulbs from its ban on mercury in vehicles.

The usage of HID headlamps is expected to increase as introduction of less expensive, higher volume model cars continues. In 2000, about 3.5 million HID headlamps were used in the production of new cars worldwide. This amounts to less than 4 pounds of mercury. While this amount of mercury pales in comparison with the metric tons of mercury used in automotive switch applications, it is desirable to eliminate this source of mercury from the waste stream, if possible.

Considerable effort has been expended in recent years to produce Hg free lamps that operate at high voltages so they can be used as retrofits with existing ballasts. Examples where high doses of metal additives are used to elevate the voltage are described by Ishigami et al. in EP 0 883 160 A1, by Takeda et al. in EP 1 032 010 A1 and Uemura et al. in EP 1 150 337 A1. Examples of other voltage enhancing additives are described by Takahashi et al. in EP 1 172 839 A2, and by Takahashi et al. in U.S. Pat. No. 6,265,827. Examples of high efficacy fills of a corrosive or toxic nature are described by Kaneko et al. in EP 1 172 840 A2.

In considering the elimination of mercury in the manufacture of an electric lamp, an acceptable alternate fill material is required. One problem involved in making such a selection is that during operation of the lamp, fill condensate in the arc stream region between opposing lamp electrodes tends to wet the inner wall adjacent the arc stream region and cause a film of such condensate on such wall thereby coating the light transmitting portions of the lamp envelope and impeding light transmission. Another problem is that the presence of such condensate in the arc stream region tends to provide a less than desirable color stable source. A further problem is that movement of such condensate in the arc stream region during lamp operation causes the lamp to flicker. Further, some replacement fill materials are so volatile that they extinguish the arc during lamp start-up. Although voltage within the lamp may be enhanced using fill materials having easily vaporized chemistries, the doses of such materials to produce acceptable voltage drop for lamp operation tend to cause unstable operation in quartz lamp prototypes.

For demanding optical applications, such as a headlamp or medical illumination system, transparent material for the arc tube body is preferred. Fused silica is commonly used now, but ceramics are also possible, and indeed necessary for operation at higher temperatures or with certain reactive chemistries. The scattering nature of polycrystalline alumina, a perfectly good material for general illumination, reduces the arc luminance and adversely affects the system etendue. The best optical coupling of ceramic metal halide lamps to reflectors or fiber systems will be achieved with transparent ceramic vessels.

U.S. Pat. No. 5,621,275 discloses a sapphire arc tube enclosed with a polycrystalline alumina (PCA) cap through an interference (sintering shrinkage) of the PCA cap against the sapphire arc tube, for an electrodeless arc discharge lamp. PCA arc tubes enclosed with PCA caps through the direct joint are also described in the same patent.

International patent application WO 99/41761 describes a monolithic seal for a sapphire ceramic metal halide lamp. The monolithic seal employs the PCA cap approach of U.S. Pat. No. 5,621,275, except that electrode feedthroughs that are frit-sealed to capillaries are included.

### DISCLOSURE OF THE INVENTION

It is an object of the present invention to provide an improved electric lamp, and method of operating same.

It is another object of the present invention to obviate the disadvantages of the prior art by providing an improved electric lamp, and method of operating same.

A further object of the present invention is to provide an economical, efficient and high quality electric lamp, and method of operating same.

Another object of the present invention is to provide an electric lamp wherein excess condensate of the fill material within the lamp envelope is removed from the arc stream region during lamp operation, and method of operating same.

Yet a further object of the present invention is to provide an electric lamp having reduced color shifting and flicker, and method of operating same.

A further object of the present invention is to provide an electric lamp having a well-defined temperature zone in which chemical fill condensate resides during lamp operation, and method of operating same.

Yet a further object of the present invention is to provide an electric lamp wherein the arc is not extinguished during start-up, and method of operating same.

Another object of the present invention is to provide an electric lamp having easily vaporizable fill chemistries that do not cause unstable lamp operation, and method of operating same.

Another object of the present invention is to provide an improved metal halide lamp, and method of operating same. Another object of the present invention is to provide an electric lamp having a ceramic envelope which can be dosed at a higher salt level relative to a conventional electric lamp having a silica envelope thereby permitting lamp operation at relatively higher voltages without the need for mercury, and method of operating same.

Yet a further object of the present invention is to provide an improved electroded transparent ceramic mercury free lamp, and method of operating same.

This invention achieves these and other objects by providing an electric lamp comprising a sealed envelope having a wall defining an enclosed volume. At least a portion of the wall is a substantially clear light transmissive window. The enclosed volume comprises one cavity open to at least one other cavity. A fill material is contained in the enclosed volume. At least one electrode is provided, the electrode being sealed through the wall and extending from a first electrode end within the one cavity to a second electrode end exterior of the envelope for electrical contact. The enclosed volume is so structured and arranged, and the fill material is of such a chemical composition, that in an operational mode of the lamp, fill material vaporizes in the one cavity and excess fill material condenses in the other cavity. The other cavity provides a cooler region within the enclosed volume than the one cavity during the operational mode. A method of operating the electric lamp is also provided comprising the steps of initiating energization of the lamp in a lamp initiation mode; vaporizing the fill material in the one cavity; and condensing excess fill material in the other cavity.

### BRIEF DESCRIPTION OF THE DRAWINGS

This invention may be clearly understood by reference to the attached drawings in which like reference numerals designate like parts and in which:

FIG. 1 is an illustration of one embodiment of an electric lamp of the present invention;

FIG. 2 is an illustration of another embodiment of an electric lamp of the present invention;

FIG. 3 is an illustration of one embodiment of an end cap useful in the present invention;

FIG. 4 is an illustration of another embodiment of an end cap useful in the present invention;

FIG. 5 is an illustration of one of two identical ends of a further embodiment of a lamp of the present invention.

FIG. 6 is another view of the embodiment of the lamp of the present invention illustrated in FIG. 2; and

FIG. 7 is a graph illustrating spectral output of a lamp according to the present invention.

### MODE FOR CARRYING OUT THE INVENTION

For a better understanding of the present invention, together with other and further objects, advantages and capabilities thereof, reference is made to the following disclosure and appended claims taken in conjunction with the above-described drawings.

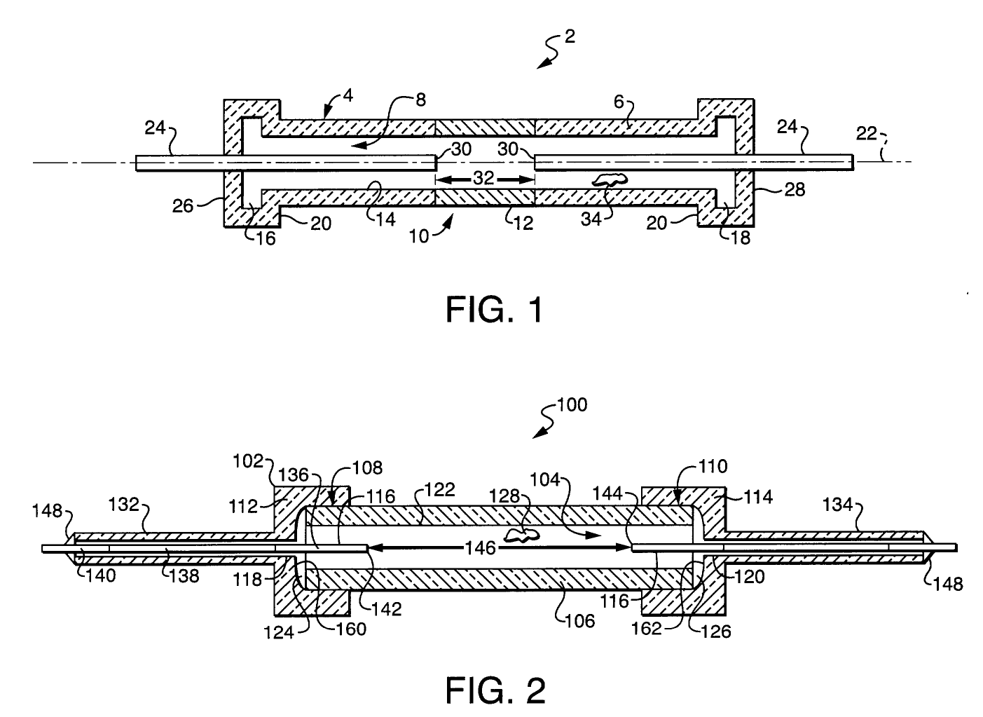

FIG. 1 is an illustration of one embodiment of a lamp of the present invention. In the embodiment of FIG. 1, an electric lamp 2 is provided which comprises a sealed envelope 4. Without limitation, envelope 4 may be fabricated from a ceramic material. Envelope 4 includes a wall 6 that defines an enclosed volume 8. At least a portion 10 of the wall 6 is a substantially clear light transmissive window 12 through which light may be emitted from within the enclosed volume 8, the remaining portion being translucent or opaque. In one alternate embodiment, the wall 6 may be transparent throughout its length. The enclosed volume 8 comprises one cavity that forms a main portion of the enclosed volume open to at least one other cavity that provides a subportion of the enclosed volume. For example, in the embodiment illustrated in FIG. 1, enclosed volume 8 comprises one cavity formed by wall 14 open to two cavities 16, 18, one at each end of the lamp 2. Each cavity 16, 18 is open to the cavity formed by wall 14 at a respective end of the cavity formed by wall 14. In the embodiment illustrated in FIG. 1, each cavity 16, 18 is a recessed subportion formed by flanged portions 20 of the wall 6, the flanged portions extending circumferentially about axis 22 of the envelope 4. As explained in more detail herein, each recessed subportion 16, 18 provides a reservoir that is remote to the lamp discharge volume located in the cavity 14.

At least one electrode is provided sealed through the wall which forms the sealed envelope 4, the electrode extending from one electrode end within the cavity formed by wall 14 to a second electrode end exterior of the envelope for electrical contact in a conventional manner. For example, in the embodiment illustrated in FIG. 1, two opposed electrodes 24 are sealed through the wall 6 at respective wall ends 26 and 28 of the envelope 4. Respective ends 30 of the two opposed electrodes 24 face each other within the cavity 14 and are separated by an arc stream region or gap 32 which provides the lamp discharge volume between the electrodes in the conventional manner. The arc stream region 32 is adjacent the window 12, and during lamp operation emits light through the window, the arc stream region being the hottest region of the lamp.

The lamp 2 includes a fill material 34 within the enclosed volume 8. In the preferred embodiment, the fill material is mercury free and highly volatile. The enclosed volume 8 is structured and arranged such that in an operational mode of the lamp, the fill material 34 vaporizes in the cavity formed by wall 14, excess fill material gravitating to and condensing in the cavities 16, 18. To this end, each section of wall 6 adjacent the recessed subportions 16, 18 is structured and arranged to provide sufficient heat radiation to maintain a lower temperature in the recessed subportions 16, 18 than in the arc stream region 32 where heating of the plasma is localized between electrode tips during normal lamp operation. For example, each wall section of wall 6 adjacent the recessed subportions 16, 18 is provided in such a manner as to (a) form adequate volume to contain the condensed excess chemical fill and (b) be located at a relatively greater distance in comparison to the window 12 from the arc stream region 32, to provide a lamp cold spot to which such condensate can migrate during lamp operation. As a practical matter, in this manner there is enhanced condensation of excess fill material in the recessed subportions 16, 18 relative to the arc stream region 32.

FIG. 2 illustrates another embodiment of the present invention. In the embodiment illustrated in FIG. 2, a lamp 100 is provided which comprises a sealed envelope 102 having a wall that defines an enclosed volume 104. In this embodiment, the wall which forms the sealed envelope 102 comprises a tubular portion 106, having a first end portion 108 and an opposite second end portion 110, a first cap 112 attached to the first end portion, and a second cap 114 attached to the second end portion. A first electrode 116 extends through the cap 112 at 118, and a second electrode 116 extends through the cap 114 at 120.

In the embodiment illustrated in FIG. 2, the enclosed volume 104 includes one cavity, within the tubular portion 106, formed by wall 122 of the tubular portion, a second cavity 124 between the tubular portion and first cap 112, and a third cavity 126 between the tubular portion and the second end cap 114. Cavities 124 and 126 perform the same function as cavities 16 and 18 of the embodiment of FIG. 1. The volume of the cavities 124 and 126 may be controlled by cap configuration and shrinkage of each cap during fabrication of the lamp 100 as explained herein. Each cavity 124 and 126 is located between the tubular portion 106 and each respective cap 112, 114 at a respective end of the tubular portion. In an operational mode of the lamp 100, a mercury-free fill material 128 contained within the enclosed volume 104 vaporizes in the cavity formed by wall 122, excess fill material migrating to and condensing in the cold spots provided at cavities 124 and 126. As in the embodiment of FIG. 1, cavities 124 and 126 provide a cooler region within the enclosed volume 104 than the cavity formed by wall 122, during the operational mode.

In the example illustrated in FIG. 2, the caps 112 and 114 each include extended capillary sections 132 and 134, respectively, which form capillaries through which respective electrodes 116 extend. The caps 112 and 114 fit onto the tubular portion 106 and are sintered thereto to provide a hermetic arc tube that forms the body of lamp 100. The capillary sections 132 and 134 extend away from enclosed volume 104. In the embodiment illustrated in FIG. 2, each electrode 116 includes a length 136 of tungsten, a length 138 of molybdenum and a length 140 of niobium. The electrodes 116 are inserted through the end caps 112 and 114 at the respective capillary sections 132 and 134, such that respective electrode ends 142 and 144 face each other.

The arc stream region between the ends 142 and 144 provides the lamp discharge volume 146. The electrodes 116 are sealed into the capillary sections 132 and 134 with a frit glass 148 in a conventional manner. It should be noted that the end of each capillary section 132 and 134 adjacent respective cavities 124 and 126 is open to the enclosed volume 104. Therefore, some of the condensate formed during lamp operation will migrate into the capillaries formed by the capillary sections 132 and 134. However, the volume and location of such capillaries is such that the capillaries do not provide a satisfactory cold spot for collection of excess fill condensate. To the contrary, in the absence of cavities 124 and 126, the fill condensate will be distributed randomly and will tend to ooze back into the arc tube body, that is, the volume provided by the surface 122, and cause corrosion.

This results from the fact that the melt pool is spacially extended over a region where a temperature gradient and hence solubility gradient exists. The cavities 124, 126, on the other hand, act as a receptacle for the fill condensate that would ordinarily ooze into the arc tube body, the condensate being trapped within the “moat-like” cavities.

Prior to final sealing, the lamp is dosed with the chemical fill material, filled with inert gas and hermetically sealed in a conventional manner. Some examples of the fill material and inert gas are discussed herein.

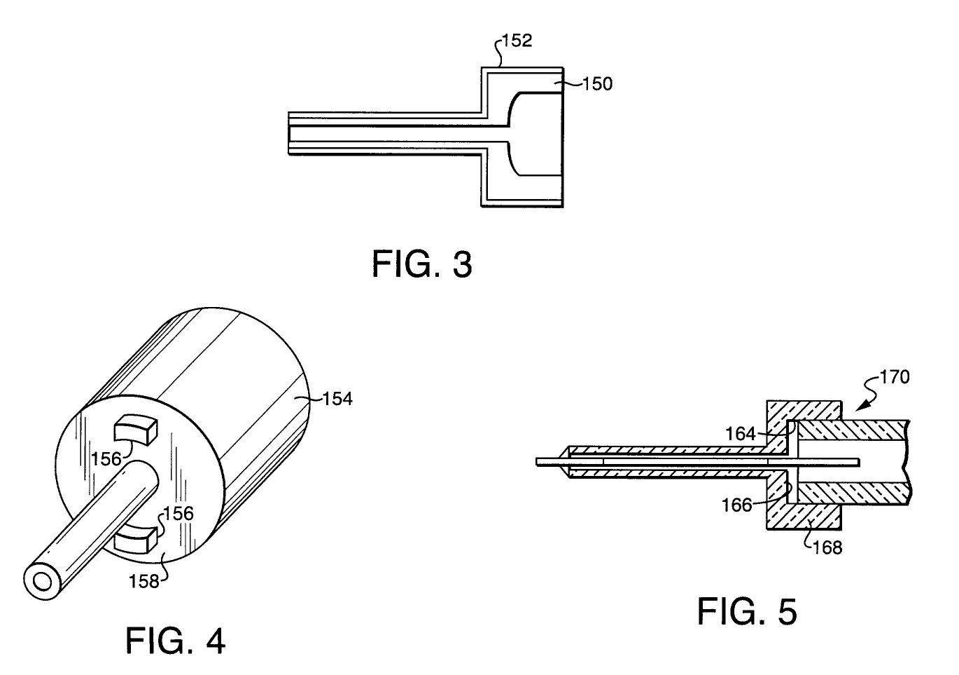

In a preferred embodiment of FIG. 2, the lamp 100 is a metal halide lamp that is made from three pieces: a transparent cylindrical tubular portion 106, and two translucent polycrystalline molded end caps 112 and 114. The end caps 112 and 114 are sintered onto the cylindrical portion 106. The cylindrical portion 106 is a substantially transparent ceramic material such as a single crystal fully dense sapphire tube. Such material is readily available commercially. Without limitation, other transparent ceramic materials such as yttrium alumina garnet (YAG) could also be used. The caps 112 and 114 are PCA. In the manufacturing of the lamp 100, the caps 112 and 114 are structured and arranged such that during sintering of the caps to the tubular portion 106, shrinkage of the caps increases the volume of cavities 124 and 126 and affixes the caps to the tubular portion. This results from the facts that during sintering the PCA caps 124 and 126 shrink as they densify, but the ceramic tubular portion 106, being fully dense, does not. During operation of the lamp 100, the cavities 124 and 126 hold the excess condensed fill material. In essence, the cavities 124 and 126 act as a constant temperature reservoir of the condensed fill material. By manipulating the shape and degree of shrinkage of the cap to control the configuration of the cavities 124 and 126, the volume of the cavities 124 and 126 can be controlled to contain the desired amount of the excess condensed fill material produced during lamp operation. Similarly, by adjusting the thickness of the cap walls, or by the addition of exterior heat sinking, or radiating features on the cap, the caps can function as heat sinks to further adjust the temperature of the condensate reservoirs. For example, FIG. 3 illustrates a cap 150 similar to caps 112 and 114 wherein the cap 150 includes a surface coating 152, which promotes thermal radiation. Without limitation, coating 152 may be a graphite, refractory metal or metal oxide end paint. In another example illustrated in FIG. 4, a cap 154 similar to caps 112 and 114 includes projections 156 along the cap surface 158 to promote thermal radiation.

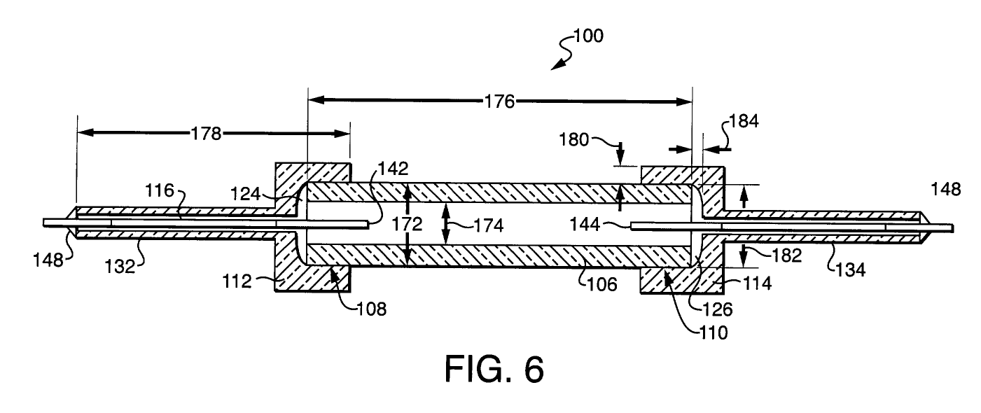

The recessed cavities 124 and 126 are illustrative of one configuration of recessed subportions that provide cold spots for condensed excess fill material during lamp operation. FIG. 5 illustrates another embodiment of a lamp of the present invention identical to the embodiment of FIG. 2 with the exception of the configuration of the inner wall of the end caps, and recessed cavities formed thereby, only one end cap being illustrated. In particular, in FIG. 2 an inner wall of each end cap 112, 114 is meniscus (dish) shaped at walls 160 and 162. In contrast, in the embodiment of FIG. 5, the inner walls 164 and 166 of end cap 168 of lamp 170 are flat. The embodiment of FIG. 5 is identical to the embodiment of FIG. 6 with the exception of the inner walls 164 and 166.

Referring once again to FIG. 2, the reservoirs formed at cavities 124 and 126 control the melt temperature within the lamp 100. The cavities 124 and 126 are closer to the lamp discharge volume, and therefore the lamp arc, than are the capillaries formed by the capillary sections 132 and 134, and as such are the hottest reservoirs provided for the salt condensate thereby controlling the vapor pressure and composition of the gases within the lamp during lamp operation. As a result of the migration of the fill material condensate from the arc stream region to the cooler reservoirs 124 and 126, the condensate does not wet the inner wall 122 and cause a film of salt on the interior of the arc chamber. Consequently, vapor material for the plasma within the enclosed volume 104 may be provided at constant pressure, but without condensate coating the light emitting portions of the clear sapphire and impeding light transmission. This provides a more color stable source and one substantially free of flicker which is important for optical applications such as use of the metal halide lamp as a headlight or projector source. A source of lamp flicker is introduced when the film of salt moves during lamp operation.

It should be noted that some chemistries are so volatile that they extinguish the arc during lamp start-up. Easily vaporized chemistries of some fill materials such as gallium halides are often used as voltage enhancing additives in Hg free lamps. The doses of such fill material needed to produce acceptable voltage drop for lamp operation cause unstable operation in quartz lamp prototypes. The current art of producing quartz lamps leaves no reservoir for the salt, that is, the arc chamber is the only salt repository. With the present invention, the fill condensate is localized away from the arc stream region and turbulent fluid flow around the electrodes, and reduced heating of the condensate contributes to a stable, well-behaved ignition and warm up in similarly dosed lamps. In this way the lamp can be overdosed with salts, while functionally appearing to be minimally dosed.

One method of fabricating the electric lamp of the present invention will now be described with reference to the electric lamp 100, illustrated in FIGS. 2 and 6. FIG. 6 is identical to FIG. 2 and has been included so that the lamp dimensions can be clearly shown.

A single-crystal aluminum oxide (sapphire) cylindrical tubular portion 106 was obtained having a 3.15 millimeters outer diameter 172 and a 1.5 millimeters inner diameter 174. Tubular portions of this type are available from Saphikon, Inc. The tubular portion was cut into 10 millimeter lengths 176. Polycrystalline alumina end caps 112 and 114 were formed using high purity aluminum oxide powder (CR6, Baikowski) (less than 500 ppm impurities) doped with 200 ppm MgO+20 ppm Y₂O₃+400 ppm ZrO₂ as sintering aids. The doped alumina powder was mixed with a wax binder and molded to form the caps 112 and 114, including the capillary sections 132 and 134. The shape of the caps 112 and 114, and therefore the shape of the cavities 124 and 126, was determined by the shape of the mold used for forming the caps. The caps so formed were fired in air to 1000 degrees Celsius to remove the binder and strengthen and maintain the shape of the caps. The caps 112 and 114 were then placed onto respective ends 108 and 110 of the tubular portion 106 and fired vertically at 1330 degrees Celsius in air causing partial densification and shrinkage, thereby locking the caps onto the tubular portion. The assembled sapphire tubular portion 106 with end caps 112 and 114 attached thereto were then final-sintered in flowing nitrogen with 8% hydrogen at 1890 degrees Celsius for one hour. As the end caps 112 and 114 were sintered onto the sapphire tubular portion 106, a significant amount of dimensional shrinkage and densification occurred in the PCA caps, while the fully dense sapphire tubular portion remained unchanged. In this manner, a circumferential hermetic seal was formed between the sapphire and the PCA where the caps 112 and 114 were previously locked onto the tubular portion 106, and the cavities 124 and 126, which form the respective salt reservoirs, grew at the end of the tubular portion. In particular, in the embodiment illustrated in FIGS. 2 and 6, prior to sintering, the length 178 of the end caps 112, 114 was 21.4 millimeters and the thickness 180 was 0.85 millimeters. The diameter 182 of each respective cavity 124, 126 was 3.9 millimeters and the depth 184 was 0.7 millimeters. Upon completion of sintering, the length 178 was 16.3 millimeters, the thickness 180 was 0.65 millimeters, the diameter 182 was 3.15 millimeters and the depth 184 was 0.5 millimeters. It will be apparent to those skilled in the art that the predetermined shape and material of the caps 112, 114 and the degree of shrinkage thereof will determine the configuration and volume of the cavities 124, 126. It will further be apparent to those skilled in the art that by varying processing parameters such as the sintering temperature and time, the degree of shrinkage can be controlled. The degree of shrinkage and hence the final volume of the cavities 124, 126 will depend upon the volume of fill condensate the cavities will be expected to accommodate to prevent condensate interference with lamp operation. Without limitation, in lamps of the type illustrated in FIGS. 2 and 6, the depth 184 will be about 0.1 to 0.25 times the diameter 172 of the sapphire tube 106, preferably 0.1 times such diameter. Since the depth 184 is so small, the thermal gradient across the hottest melt pool is reduced. Consequently, the solubility gradient is reduced and corrosion should be reduced. In addition, since the gradient is reduced, the vapor pressure above the salt is more precisely defined, and the lamp is more color stable.

The electrodes 116 were inserted through the capillary sections 132 and 134, respectively and sealed in place using the glass frit 148. Electrodes 116 were 5 millimeters in length and 0.25 millimeters in diameter. The length of the lamp discharge volume 146 was 4.2 millimeters nominal. Prior to final sealing, the lamp was dosed in a conventional manner with a mercury-free highly volatile chemical fill material 128 and filled with xenon, an inert gas. Other rare gases and mixtures may be used. The lamp 100 was then hermetically sealed in a conventional manner.

The chemical fill of the lamp of the present invention will typically be a highly volatile fill material by which is meant that during lamp operation fill material vaporizes in the arc stream region, and excess fill material migrates to and condenses in the recessed subportion(s) of the enclosed volume of the lamp. Without limitation, the chemical fill of the present invention can include gallium, indium, thallium and aluminum halides, as for example, GaI₃, InI, InI₃, AlI₃ and TlI. Rare earth halides may also be used. Although the lamp of the present invention is particularly useful as a mercury-free lamp, mercury can be included in the chemical fill if desired. An example would be the use of mercury halides. One or more of the foregoing fill materials may be combined with other salts such as scandium halides or rare earth halides. The present invention is not limited to any particular fill material so long as the fill material vaporizes in the main portion of the lamp and condenses in the recessed subportion as described herein.

The lamp of the present invention and conventional silica lamps dosed with high concentrations of easily vaporized salts were tested and the results compared. All of the lamps were tested on a 500 Hz square wave ballast capable of developing 500 VOC and delivering more than 2 amperes. The fills in two of the conventional silica lamps tested were 1 mg GaI₃, 0.34 mg of Type 4 rare earth chemistry (19.5% DyI₃, 19.5% HoI₃, 19.5% TmI₃, 32.5% NaI and 9.0% TlI by weight) and 8 bar Xenon. The fill of a third silica lamp tested was 1 mg GaI₃, 0.8 mg InI, 0.24 mg of the same Type 4 rare earth chemistry and 8 bar Xenon. The volume of each silica lamp tested was about 23 mm³.

In testing the foregoing conventional silica lamps, each lamp would start at room temperature, but the Gallium and Indium halides would vaporize too rapidly. The vaporized fill had no place to go except into the vapor state, there being no colder region to allow for re-condensing of the vaporized fill. As a result, lamp voltage rose rapidly due to wild and uncontrolled impedance changes in the lamp, causing the lamp to extinguish and leave salt residue all over the interior surface of the arc chamber. Repeated attempts to sustain discharge in each of these silica lamps failed. It was noted that the salt splattered over the entire inner surface area, which is indicative of an abrupt, uncontrolled interruption of lamp operation.

A lamp of the present invention of the type illustrated in FIGS. 1 and 6, was fabricated using the method and dimensions described above. Whereas the volume of the silica lamps tested was about 23 mm³, the volume of the lamp of the present invention was smaller than about 19.5 mm³. Yet, the lamp of the present invention was dosed with a chemical fill of 4 mg of InI, 1 mg of NaI and 5 bar of Xenon. The average density of salt within the enclosed volume 104 was about 5 g/cc or 5 mg/mm³. The volume of each cavity 124 and 126 was about 0.5 mm³. Therefore, each cavity 124 and 126 could contain roughly half of the salt dose amount, or the full amount in both. Although some salt vaporized as the lamp heated up, the salt zone migrated to the cavities 124 and 126, which provided remote colder regions for the salt to re-condense in. It is in this manner that the salt zone was removed from the arc stream region 146 allowing the main discharge chamber to heat less rapidly than in the silica lamp. This avoided the depositing of salt residue on the interior surface of the arc chamber. In addition, the lamp operated in a stable fashion for hours. Although some of the salt condensed in the capillaries formed by the capillary regions 132, 134, the temperature distribution was such that the salt in the cavities 124, 126 was at a higher temperature than the salt in the capillary regions, such higher temperature salt controlling the vapor pressure inside of the lamp.

The lamp of the present invention allows for the use of at least 6 to 7 times as much salt on a per-volume basis in the enclosed volume of the lamp than in a conventional silica lamp. This ability to dose at a higher salt level ultimately permits operation of the lamp at a higher voltage without the need for mercury, although mercury can be included in the fill if desired. In addition, the higher salt density in the vapor, which can be achieved in a stable fashion, provides improved radiation properties.

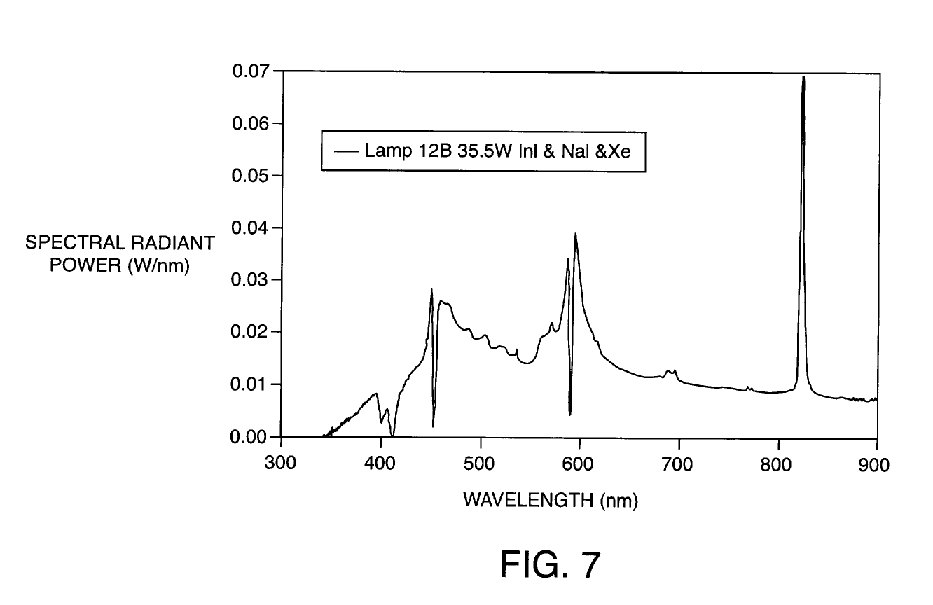

The spectral output of the foregoing tested lamp of the present invention is illustrated in FIG. 7.

The voltages seen in the mercury free conventional silica lamps with voltage enhancing additive are about 42V. Higher voltages may be achieved with reduced lamp efficacy at the onset of instability. In the lamp of the present invention, voltages on the order of 60V with stable operation are routinely seen. The higher voltage translates into less amperage for the required power levels, the lamp having the characteristics illustrated in FIG. 7 being 35W. This means that electrodes developed for use in mercury containing lamps may be used without fear of meltback or evaporation. The lower voltage silica lamps require about twice the steady state current and may have problems with excessive wall darkening due to elevated electrode tip temperature. For example, a mercury containing 35W headlamp operates at about 82V with 0.44 A.

The embodiments which have been described herein are but some of several which utilize this invention and are set forth here by way of illustration but not of limitation. It is apparent that many other embodiments which will be readily apparent to those skilled in the art may be made without departing materially from the spirit and scope of this invention.

We claim:

1. An electric lamp, comprising:
a sealed envelope having a wall defining an enclosed volume, at least a portion of said wall being a substantially clear light transmissive window, said enclosed volume comprising one cavity open to at least one other cavity;
a fill material contained in said enclosed volume; and
at least one electrode, said one electrode sealed through said wall and extending from a first electrode end within said one cavity to a second electrode end exterior of said envelope for electrical contact;
said enclosed volume being structured and arranged, and said fill material being of such a chemical composition, that in an operational mode of said lamp fill material vaporizes in said one cavity and excess fill material condenses in said at least one other cavity, said at least one other cavity providing a cooler region within said enclosed volume than said one cavity during said operational mode.

2. The lamp of claim 1 wherein said envelope comprises a tubular portion having a first end portion and an opposite second end portion, and at least a first cap, said first cap attached to said first end portion, said at least one electrode comprising a first electrode being sealed through said first cap, said one cavity being within said tubular portion, and said at least one other cavity comprising a first cavity between said tubular portion and said first cap.

3. The lamp of claim 2 further including a second cap attached to said second end portion, said at least one electrode comprising a second electrode, said at least one other cavity also comprising a second cavity between said tubular portion and said second cap, said second electrode being sealed through said second cap.

4. The lamp of claim 1 wherein said lamp is a high intensity discharge lamp and said envelope is ceramic.

5. The lamp of claim 3 wherein said tubular portion is a cylindrical single crystal tube and said first cap and said second cap are sintered to said first end portion and said second end portion, respectively, said first cap and said second cap being polycrystalline alumina.

6. A high intensity discharge lamp comprising:
a ceramic envelope having a wall defining an enclosed volume comprising a recessed subportion and a main portion having an arc stream region, the wall having a substantially clear light transmissive window adjacent the arc stream region, the recessed subportion being open to the main portion at an end of the main portion;
at least one electrode with a first electrode end and a second electrode end, the electrode being sealed through the wall, the first electrode end being exposed on the exterior of the envelope for electrical contact and the second electrode end being exposed adjacent the arc stream region;
a fill material located in the enclosed volume; and,
said envelope being structured and arranged, and said fill material being of such chemical composition, that in an operational mode of said lamp (a) a thermal gradient exists between said main portion and said recessed subportion, (b) said recessed subportion is cooler than said main portion, and (c) said fill material vaporizes in said main portion and excess fill material condenses in said recessed subportion.

7. The lamp in claim 6, wherein the fill material is substantially mercury free.

8. The lamp in claim 6, wherein a portion of the wall adjacent the recessed subportion has a relatively greater distance in comparison to the window from the arc stream region and is structured and arranged to provide sufficient heat radiation to maintain a relatively lower temperature in the recessed subportion in comparison to the arc stream region during normal lamp operation, thereby enhancing condensation of excess fill material in the recessed subportion relative to the arc stream region.

9. The lamp in claim 6, wherein the envelope comprises a clear tubular portion, which comprises the arc stream region, and a cap, the electrode being sealed through the cap and extending to the arc stream region, and the recessed subportion being exterior of the clear tubular portion.

10. The lamp in claim 9, wherein the cap is structured and arranged to lower the temperature of the recessed subportion relative to the arc stream region.

11. The lamp in claim 9, wherein the cap includes a surface coating to promote thermal radiation.

12. The lamp in claim 9, wherein the cap includes projections along the cap surface to promote thermal radiation.

13. A method of operating an electric lamp of the type comprising a sealed envelope having a substantially light transmissive window, said envelope comprising one cavity open to at least one other cavity, a fill material contained in said envelope, and at least one electrode sealed through said envelope and extending from a first electrode end within said one cavity to a second electrode end exterior of said envelope for electrical contact, comprising the steps of:
initiating energization of said lamp in a lamp initiation mode;
vaporizing said fill material in said one cavity; and
condensing excess fill material in said at least one other cavity.

14. A method of operating an electric lamp of the type comprising a ceramic envelope having a wall defining an enclosed volume comprising a recessed subportion and a main portion having an arc region, said wall comprising a substantially light transmissive window adjacent said arc stream region, said recessed subportion being open to the main portion at an end of the main portion, a first electrode and a second electrode sealed through said wall, said first electrode and said second electrode each having a first end exposed adjacent said arc stream region and a second end exposed exterior of said envelope for electrical contact, and a fill material located in said envelope, comprising the steps of:
initiating energization of said lamp in a lamp initiation mode;
forming a thermal gradient between said main portion and said recessed subportion, said recessed subportion being cooler than said main portion;
vaporizing said fill material in said main portion; and
condensing excess fill material in said recessed subportion.

15. An electric lamp, comprising:
a sealed envelope having a wall defining an enclosed volume, at least a portion of said wall being a substantially clear light transmissive window;
a fill material contained in said enclosed volume;
a first and second electrode sealed through said wall having opposed facing first ends within said enclosed volume and second ends exterior of said envelope for electrical contact; and
means for vaporizing said fill material in a first portion of said enclosed volume and condensing excess fill material in a second portion of said enclosed volume.
